(19) United States
(12) Patent Application Publication
(10) Pub. No.: US 2026/0309504 A1
(43) Pub. Date: Oct. 8, 2026

(54) ROUTE INFORMATION CREATION APPARATUS AND METHOD OF CREATING ROUTE INFORMATION

(71) Applicant: Mitsubishi Electric Mobility Corporation, Tokyo (JP)

(72) Inventors: Kentaro DAIKOKU, Tokyo (JP); Tatsunari TAKEOKA, Tokyo (JP); Yoshiaki ADACHI, Tokyo (JP); Mitsuo SHIMOTANI, Tokyo (JP)

(73) Assignee: Mitsubishi Electric Mobility Corporation, Tokyo (JP)

(21) Appl. No.: 19/108,298

(22) PCT Filed: Nov. 1, 2022
(86) PCT No.: PCT/JP2022/040904

§ 371 Date: Mar. 3, 2025

(51) Int. Cl. G01C 21/32

(52) U.S. Cl. CPC G01C 21/32

(57) ABSTRACT

A route information creation apparatus includes: a first route information obtaining unit; a second map obtaining unit; an association determination unit; and a second route information creating unit. When a second node corresponding to a specific first node does not include a second outflow link flowing out of the second node which corresponds to a first outflow link flowing out of the first node, the association information includes information for associating, with the first outflow link, another second outflow link flowing out of another second node in a vicinity of the second node, and when the second node does not include a second inflow link flowing into the second node which corresponds to a first inflow link flowing into the first node, the association information includes information for associating, with the first inflow link, another second inflow link flowing into another second node in the vicinity of the second node.

### BACKGROUND OF THE INVENTION

### Field of the Invention

The present disclosure relates to a route information creation apparatus and a route information creation method which create route information that contributes to driving assistance.

### Description of the Background Art

What has been conventionally disclosed is a technology that determines a second route corresponding to a first route on a second map represented by a format different from that of a first map database (DB), based on information on the first route which has been obtained through execution of a route search using the first map DB. For example, the technology includes an in-vehicle information (IVI) system that executes a route search using a normal definition map DB including road shape information on a per road basis as the first map DB, and an advanced driver-assistance system (ADAS) that provides driving assistance using a high-definition map DB including road shape information on a per lane basis as the second map DB. The ADAS generates second route information using the high-definition map DB, based on the first route information obtained from the IVI system (see, for example, Patent Document 1).

### PRIOR ART DOCUMENT

### Patent Document

Patent Document 1: Japanese Patent Application Laid-Open No. 2019-184493

### SUMMARY

### Problem to Be Solved by the Invention

When a road topology represented by the first map DB is identical to a road topology represented by the second map DB, the second route information associated with the first route information can be created using the technology of Patent Document 1.

When policies of collecting road information are different, when policies of creating map DBs are different, or when map development periods are different, the road topology of the first map DB may be different from the road topology of the second map DB. This causes problems in that a node or a link in the first map DB cannot be associated with a node or a link in the second map DB and the second route information corresponding to the first route information cannot be created even using the technology of Patent Document 1. Moreover, when the second route information corresponding to the first route information cannot be generated, the system using the second map DB cannot perform a proper operation.

The present disclosure has been conceived to solve such problems, and the object is to provide a route information creation apparatus and a route information creation method which can create the second route information associated with the first route information even when the road topology represented by the first map DB is different from the road topology represented by the second map DB.

### Means to Solve the Problem

To solve the problems, a route information creation apparatus according to the present disclosure includes: a first route information obtaining unit to obtain first route information including at least first node information including information for determining an inflow link or an outflow link, in a first route calculated using a first map including road shape information on a per road basis; a second map obtaining unit to obtain a second map including road shape information represented by a format different from a format of the first map; an association determination unit to determine whether the first node information included in the first route information is associated with at least one second link, based on the first route information and association information indicating a correspondence between the first node information in the first map and the second link in the second map, the first route information being obtained by the first route information obtaining unit; and a second route information creating unit to create second route information in a second route on the second map which corresponds to the first route, based on the second link determined by the association determination unit with which the first node information is associated and based on the second map obtained by the second map obtaining unit, the second route information including the second link, wherein when a second node on the second map which corresponds to a specific first node on the first map does not include a second outflow link that flows out of the second node on the second map which corresponds to a first outflow link that flows out of the specific first node, the association information includes information for associating, with the first outflow link, an other second outflow link that flows out of an other second node in a vicinity of the second node, and when the second node does not include a second inflow link that flows into the second node on the second map which corresponds to a first inflow link that flows into the specific first node, the association information includes information for associating, with the first inflow link, an other second inflow link that flows into an other second node in the vicinity of the second node.

### Effects of the Invention

The present disclosure enables creation of the second route information associated with the first route information, even when the road topology represented by the first map DB is different from the road topology represented by the second map DB.

The object, features, aspects, and advantages of the present disclosure will become more apparent from the following detailed description and the accompanying drawings.

### BRIEF DESCRIPTION OF THE DRAWINGS

FIG. 1 is a block diagram illustrating an example configuration of a route information creation apparatus according to an embodiment.

FIG. 2 is a block diagram illustrating an example configuration of an in-vehicle apparatus including a route information creation apparatus according to the embodiment.

FIG. 3 is a flowchart illustrating example operations of the route information creation apparatus according to the embodiment.

FIG. 4 is a diagram for illustrating the first node information according to the embodiment.

FIG. 5 is a diagram for illustrating the first node information according to the embodiment.

FIG. 6 is a diagram for illustrating the first node information according to the embodiment.

FIG. 7 is a diagram for illustrating the first node information according to the embodiment.

FIG. 8 illustrates example association information according to the embodiment.

FIG. 9 illustrates an example real road geometry according to the embodiment.

FIG. 10 illustrates an example road topology that represents the road geometry in FIG. 9 using a second map.

FIG. 11 illustrates an example road topology that represents the road geometry in FIG. 9 using the first map.

FIG. 12 illustrates example association information in the road geometry in FIG. 9.

FIG. 13 illustrates an example of the first route information according to the embodiment.

FIG. 14 illustrates an example of the second route information according to the embodiment.

FIG. 15 illustrates example association information according to the embodiment.

FIG. 16 illustrates an example of the second route information according to the embodiment.

FIG. 17 illustrates an example of the first route information according to the embodiment.

FIG. 18 illustrates an example of the second route information according to the embodiment.

FIG. 19 illustrates example association information according to the embodiment.

FIG. 20 illustrates an example real road geometry according to the embodiment.

FIG. 21 illustrates an example road topology that represents the road geometry in FIG. 20 using the second map.

FIG. 22 illustrates an example road topology that represents the road geometry in FIG. 20 using the first map.

FIG. 23 illustrates example association information in the road geometry in FIG. 20.

FIG. 24 illustrates an example of the first route information according to the embodiment.

FIG. 25 illustrates an example of the second route information according to the embodiment.

FIG. 26 illustrates example association information according to the embodiment.

FIG. 27 illustrates an example of the second route information according to the embodiment.

FIG. 28 illustrates an example of the first route information according to the embodiment.

FIG. 29 illustrates an example of the second route information according to the embodiment.

FIG. 30 illustrates an example association information according to the embodiment.

FIG. 31 illustrates example of the second route information according to the embodiment.

FIG. 32 illustrates an example real road geometry according to the embodiment.

FIG. 33 illustrates an example road topology that represents the road geometry in FIG. 32 using the second map.

FIG. 34 illustrates an example road topology that represents the road geometry in FIG. 32 using the first map.

FIG. 35 illustrates example association information in the road geometry in FIG. 32.

FIG. 36 illustrates an example of the first route information according to the embodiment.

FIG. 37 illustrates an example of the second route information according to the embodiment.

FIG. 38 illustrates example association information according to the embodiment.

FIG. 39 illustrates an example of the second route information according to the embodiment.

FIG. 40 illustrates an example real road geometry according to the embodiment.

FIG. 41 illustrates an example road topology that represents the road geometry in FIG. 40 using the second map.

FIG. 42 illustrates an example road topology that represents the road geometry in FIG. 40 using the first map.

FIG. 43 illustrates example association information in the road geometry in FIG. 40.

FIG. 44 illustrates an example road topology represented by the first map according to the embodiment.

FIG. 45 illustrates an example road topology represented by the second map according to the embodiment.

FIG. 46 illustrates example association information according to the embodiment.

FIG. 47 is a diagram for illustrating the first node information according to a modification of the embodiment.

FIG. 48 is a diagram for illustrating the first node information according to a modification of the embodiment.

FIG. 49 is a diagram for illustrating the first node information according to a modification of the embodiment.

FIG. 50 is a diagram for illustrating the first node information according to a modification of the embodiment.

FIG. 51 illustrates example association information according to a modification of the embodiment.

FIG. 52 illustrates an example hardware configuration of the route information creation apparatus according to the embodiment.

FIG. 53 illustrates an example hardware configuration of the route information creation apparatus according to the embodiment.

### DESCRIPTION OF THE PREFERRED EMBODIMENTS

### Embodiment

### Configuration

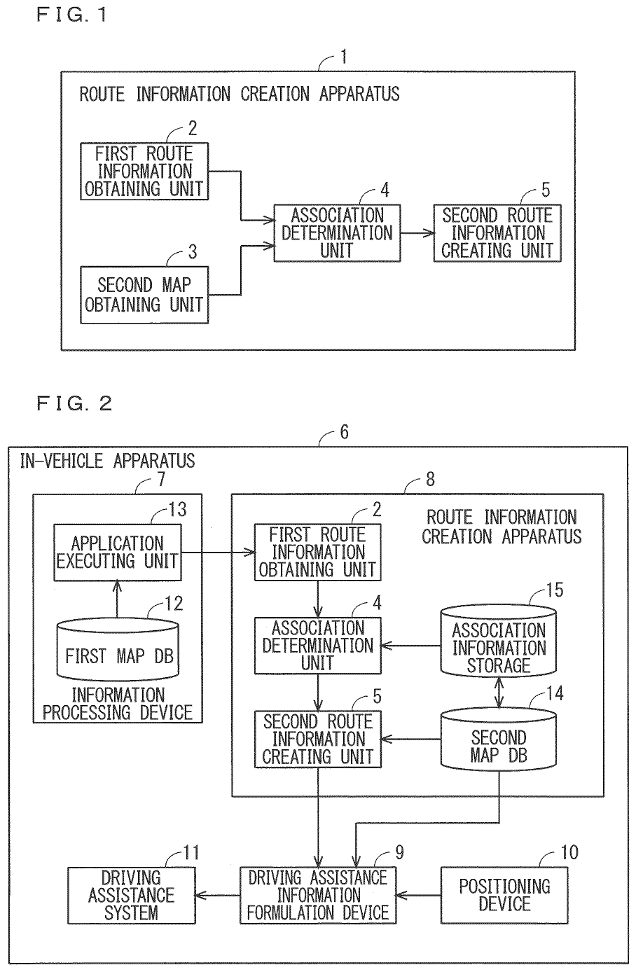

FIG. 1 is a block diagram illustrating an example configuration of a route information creation apparatus 1 according to an embodiment. FIG. 1 illustrates the minimum constituent elements of the route information creation apparatus according to the embodiment.

The route information creation apparatus 1 includes a first route information obtaining unit 2, a second map obtaining unit 3, an association determination unit 4, and a second route information creating unit 5.

The first route information obtaining unit 2 obtains first route information including at least one piece of first node information including information for determining an inflow link or an outflow link, in a first route calculated using a first map including road shape information on a per road basis.

The second map obtaining unit 3 obtains a second map including road shape information represented by a format different from that of the first map.

The association determination unit 4 determines whether the first node information included in the first route information is associated with a second link on the second map, based on the first route information obtained by the first route information obtaining unit 2, and association information indicating a correspondence between the first node information on the first map and the second link.

In the absence of a second outflow link flowing out of a second node on the second map which corresponds to a first outflow link flowing out of a first node on the first map, the association information includes information for associating another second outflow link flowing out of another second node in the vicinity of the second node with the first outflow link. Furthermore, in the absence of a second inflow link flowing into the second node on the second map which corresponds to a first inflow link flowing into the first node on the first map, the association information includes information for associating another second inflow link flowing into another second node in the vicinity of the second node with the first inflow link.

The second route information creating unit 5 creates, in a second route on the second map which corresponds to the first route, second route information including the second link based on the at least one second link determined by the association determination unit 4 with which the first node information is associated, and based on the second map obtained by the second map obtaining unit 3.

Next, another configuration of a route information creation apparatus including the route information creation apparatus 1 in FIG. 1 will be described.

FIG. 2 is a block diagram illustrating an example configuration of an in-vehicle apparatus 6 including a route information creation apparatus 8 with the other configuration.

The in-vehicle apparatus 6 includes an information processing device 7, the route information creation apparatus 8, a driving assistance information formulation device 9, a positioning device 10, and a driving assistance system 11.

The route information creation apparatus 8 is applicable to not only the in-vehicle apparatus 6 but also a Portable Navigation Device (PND) that can be mounted in a vehicle, and a device built as a system by appropriately combining, for example, a server disposed outside of the vehicle. Here, functions or constituent elements of the route information creation apparatus 8 are dispersively allocated to functions building the system.

Although FIG. 2 illustrates a case where the information processing device 7, the route information creation apparatus 8, the driving assistance information formulation device 9, the positioning device 10, and the driving assistance system 11 are separately provided, these devices may be optionally combined and configured as a single device. For example, the route information creation apparatus 8, the driving assistance information formulation device 9, and the driving assistance system 11 may be integrally configured.

The information processing device 7 corresponds to the aforementioned IVI system, and is, for example, a navigation device. The information processing device 7 includes a first map DB 12 and an application executing unit 13. The information processing device 7 may be disposed outside of the vehicle.

The first map DB 12 is a storage medium such as a memory or a hard disk drive (HDD), and stores the first map (a normal definition map) including road shape information on a per road basis. The first map DB 12 may be disposed in the in-vehicle apparatus 6 separately from the information processing device 7, or disposed outside of the vehicle.

The application executing unit 13 executes, for example, a navigation function, using the first map stored in the first map DB 12. Examples of the navigation function include a traveling route search and traveling route prediction. The information processing device 7 outputs, to the route information creation apparatus 8, the first route information including the first node information which corresponds to the first route obtained through execution by the application executing unit 13. The application executing unit 13 performs a traveling route search or traveling route prediction, using a position of the vehicle determined by a positioning unit that is included in the information processing device 7 and is not illustrated or using a position of the vehicle determined by the positioning device 10.

The route information creation apparatus 8 includes the first route information obtaining unit 2, the association determination unit 4, the second route information creating unit 5, a second map DB 14, and an association information storage 15.

The first route information obtaining unit 2 obtains the first route information from the information processing device 7.

The second map DB 14 is a storage medium such as a memory or an HDD, and stores the second map (a high-definition map) including the road shape information on a per lane basis. Although the route information creation apparatus 8 includes the second map DB 14, the route information creation apparatus 8 may include the second map obtaining unit 3, instead of the second map DB 14. Furthermore, the second map DB 14 may be disposed in the in-vehicle apparatus 6 separately from the route information creation apparatus 8, or disposed outside of the vehicle.

The association information storage 15 stores the association information indicating a correspondence between the first node information on the first map and the second link on the second map. The association information storage 15 may be disposed in the in-vehicle apparatus 6 separately from the route information creation apparatus 8, or disposed outside of the vehicle.

The association determination unit 4 determines whether the first node information included in the first route information obtained by the first route information obtaining unit 2 is associated with the second link, based on the first node information and the association information stored in the association information storage 15.

The second route information creating unit 5 determines the second route on the second map which corresponds to the first route, based on the first route information, the association information, and the second map, and creates the second route information including the second link in the second route. The second route information creating unit 5 outputs the created second route information to the driving assistance information formulation device 9.

The positioning device 10 determines the current position of the vehicle, using a global navigation satellite system (GNSS). Furthermore, the positioning device 10 may determine the current position of the vehicle in consideration of detection results from, for example, a gyro sensor and a vehicle speed sensor that are installed in the vehicle and are not illustrated.

The driving assistance information formulation device 9 formulates driving assistance information on traveling through the second route, based on the second route information created by the second route information creating unit 5, the second map stored on the second map DB 14, and the position of the vehicle which has been determined by the positioning device 10. The driving assistance information formulation device 9 outputs the formulated driving assistance information to the driving assistance system 11. Examples of the driving assistance information on traveling through the second route include lane shape information which corresponds to the second route.

The driving assistance system 11 provides driving assistance to the driver of the vehicle, based on the driving assistance information obtained from the driving assistance information formulation device 9. Examples of the driving assistance include automated driving, ADAS, and notification assistance.

### Operations

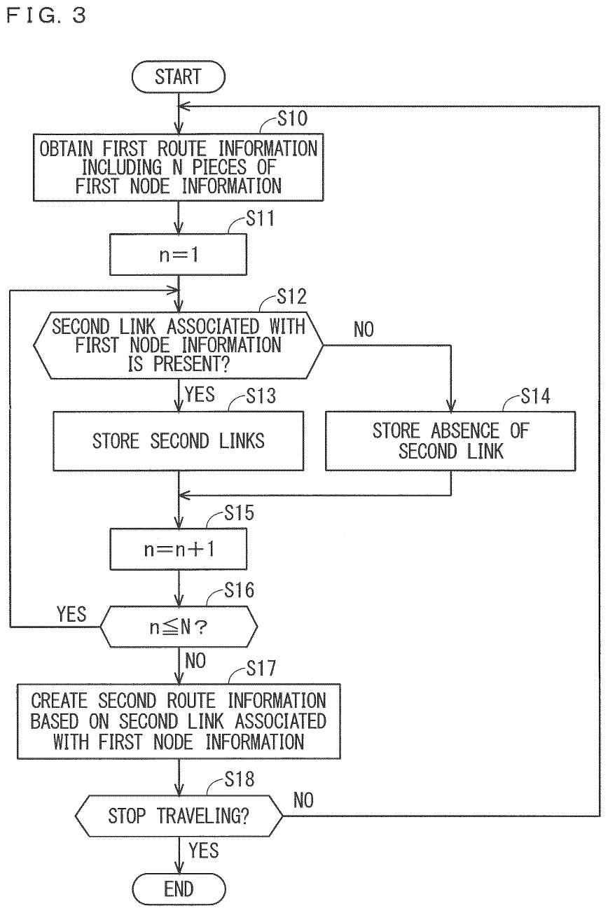

FIG. 3 is a flowchart illustrating example operations of the route information creation apparatus 8. Once the vehicle starts traveling, the application executing unit 13 of the information processing device 7 performs a route search or route prediction, using the first map stored in the first map DB 12, and generates the first route information including the first node information in the first route. Then, the information processing device 7 transmits, to the route information creation apparatus 8, the first route information generated by the application executing unit 13.

In Step S10, the first route information obtaining unit 2 obtains, from the information processing device 7, the first route information including N pieces of the first node information which corresponds to the first route. The information processing device 7 may transmit all the pieces of the first node information from the beginning to the end of the first route, or exclusively transmit the first node information according to a predefined rule. Examples of the predefined rule include a rule of transmitting the first node information within a certain distance (e.g., 10 km) from a vehicle in which the in-vehicle apparatus 6 is mounted, a rule of transmitting the first node information on a per map mesh basis, and a rule of transmitting pieces of the first node information as many as the number of predefined nodes (e.g., up to 10). The predefined rule may be any rule except these rules. The information processing device 7 may repeatedly transmit the first route information at a certain cycle or at certain traveling distances.

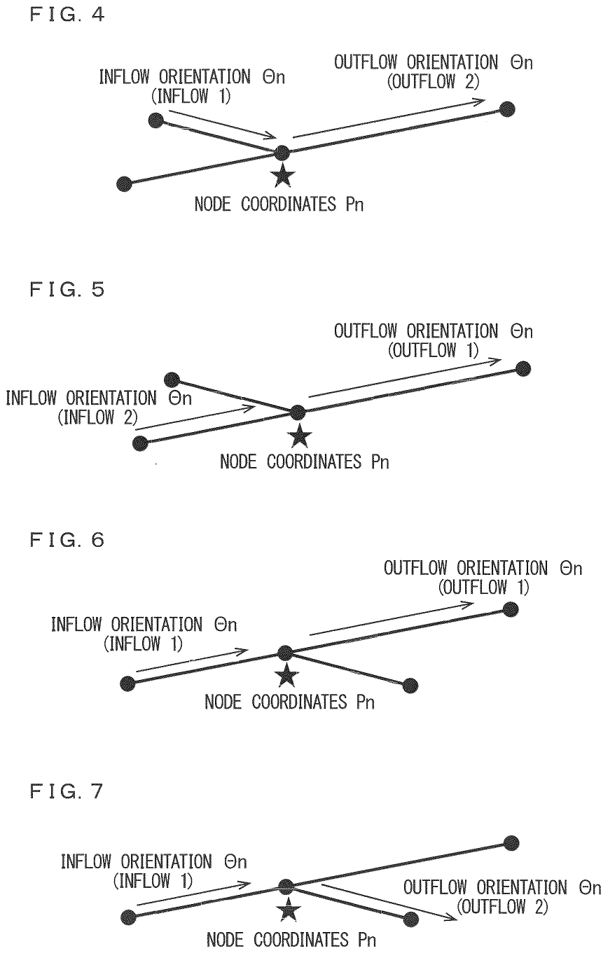

FIGS. 4 to 7 are diagrams for illustrating the first node information. As illustrated in FIGS. 4 to 7, the first node information includes, on the first node n, node coordinates Pn, an inflow orientation θn (an inflow i, a first inflow link orientation), and an outflow orientation θn (an outflow j, a first outflow link orientation).

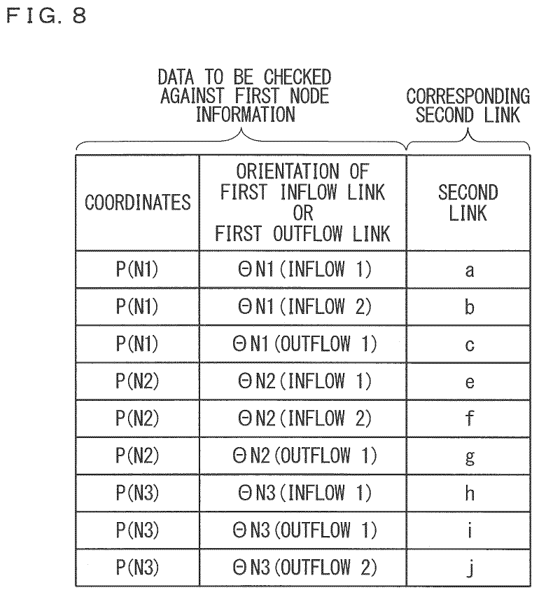

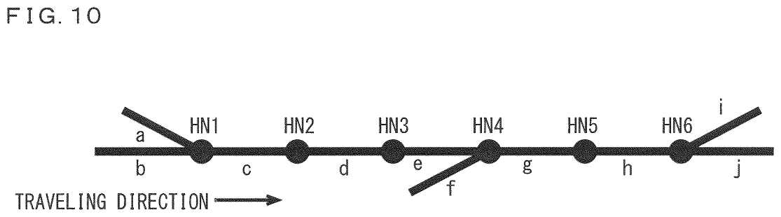

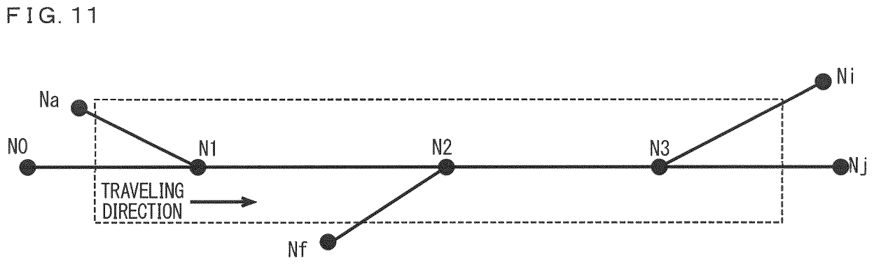

Here, association information indicating a correspondence between the first node information and the second link will be described. FIG. 8 illustrates example association information. The association information in FIG. 8 corresponds to association information in a range of a road illustrated in FIGS. 10 and 11 to be described later. An association information creating system that is not illustrated executes a predefined association information creating process (a first creating process and a second creating process) to create the association information. The first creating process and the second creating process will be described in order. The route information creation apparatus 8 according to the embodiment is characterized by creating the second route information using the association information created by the second creating process.

In the first creating process, the association information creating system checks the road topology of the first map against the road topology of the second map in the same section. Then, when the second node on the second map which corresponds to a specific first node on the first map has the second outflow link on the second map which corresponds to the first outflow link that flows out of the specific first node, the association information creating system creates information for associating the first outflow link with the second outflow link. Furthermore, when the second node on the second map which corresponds to the first node on the first map has the second inflow link on the second map which corresponds to the first inflow link that flows into the specific first node, the association information creating system creates information for associating the first inflow link with the second inflow link.

In the second creating process, the association information creating system checks the road topology of the first map against the road topology of the second map in the same section. Then, when the second node on the second map which corresponds to the first node on the first map does not have the second outflow link that flows out of the second node on the second map which corresponds to the first outflow link that flows out of the specific first node, the association information creating system selects another second outflow link that flows out of another second node in the vicinity of the second node, and creates information for associating the selected other second outflow link with the first outflow link. Furthermore, when the second node on the second map which corresponds to the first node on the first map does not have the second inflow link that flows into the second node on the second map which corresponds to the first inflow link that flows into the specific first node, the association information creating system selects another second inflow link that flows into another second node in the vicinity of the second node, and creates information for associating the selected other second inflow link with the first inflow link.

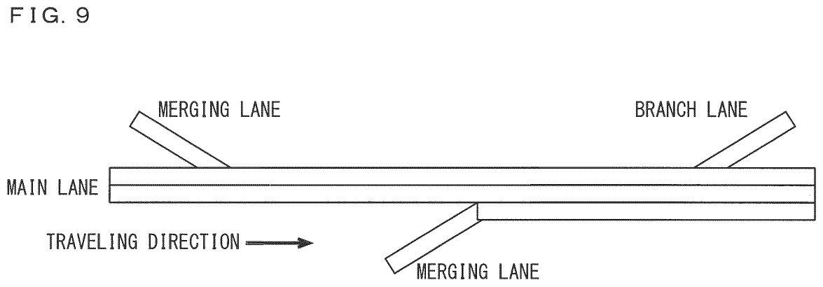

FIG. 9 illustrates an example real road geometry (a road structure) when the first map and the second map have the same road topology. FIG. 9 illustrates two merging lanes and one branch lane with respect to a main lane consisting of two lanes.

FIG. 10 illustrates an example road topology that represents the road geometry in FIG. 9 using the second map. In FIG. 10, “HN1, HN2, HN3, HN4, HN5, HN6” denote numbers (second node numbers) of nodes (second nodes) on the second map. Furthermore, “a, b, c, d, e, f, g, h, i, j” denote numbers (second link numbers) of links (second links) on the second map. In FIG. 10, links of a plurality of lanes are represented by one road link to facilitate the description.

FIG. 11 illustrates an example road topology that represents the road geometry in FIG. 9 using the first map. In FIG. 11, “N0, N1, N2, N3, Na, Nf, Ni, Nj” denote numbers (first node numbers) of nodes (first nodes) on the first map. The range of the first map enclosed by a dashed line in FIG. 11 corresponds to the range of the second map in FIG. 10.

Although the number of the first nodes does not always match that of the second nodes due to differences in map format as illustrated in FIGS. 10 and 11, the road topologies in the first nodes corresponding to a merging point and a branching point match the road topologies in the second nodes. For example, a link connection topology in the first node N1 corresponding to a merging point matches a link connection topology in the second node HN1 corresponding to the first node N1. Specifically, first links Na-N1, N0-N1, and N1-N2 are in one-to-one correspondence with second links a, b, and c, respectively. This holds true for the second node HN4 corresponding to the first node N2 corresponding to a merging point, and the second node HN6 corresponding to the first node N3 corresponding to a branching point.

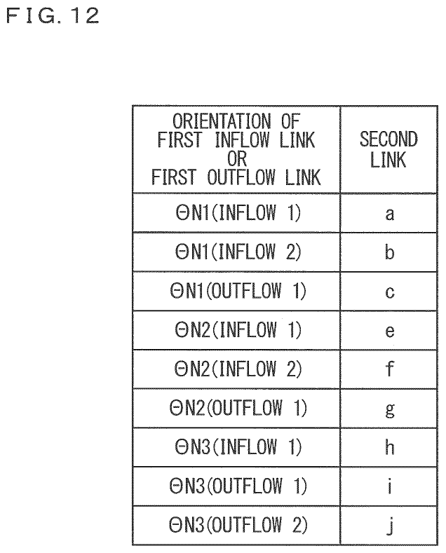

FIG. 12 illustrates example association information in the road geometry in FIG. 9. As illustrated in FIG. 12, the association information storage 15 stores the association information indicating a correspondence between the first inflow link or the first outflow link included in the first node information on the first map and the second link on the second map. FIG. 12 omits the illustration of coordinates included in the first node information to facilitate the description.

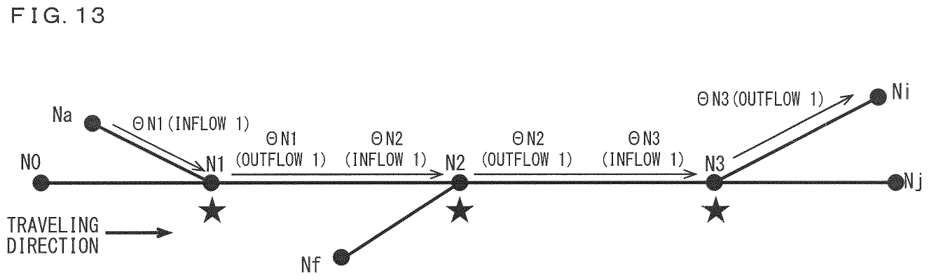

FIG. 13 illustrates an example of the first route information. FIG. 13 illustrates a case where the application executing unit 13 of the information processing device 7 has searched the first route that passes through the first nodes Na→N1→N2→N3→Ni. Here, the first route information obtaining unit 2 of the route information creation apparatus 8 obtains the first route information including the first node information in the first nodes N1, N2, and N3 (star marks in FIG. 13) from the information processing device 7.

Referring back to the description on FIG. 3, the association determination unit 4 sets n=1 in Step S11.

In Step S12, the association determination unit 4 determines the presence or absence of the second link associated with the first node information. Specifically, the association determination unit 4 compares the n-th first node information with the association information, and determines the presence or absence of the second link associated with node coordinates, an orientation (the inflow link orientation) of the first inflow link, and an orientation (the outflow link orientation) of the first outflow link which are included in the n-th first node information. In the presence of the second link associated with the first node information, the processes proceed to Step S13. In the absence of the second link associated with the first node information, the processes proceed to Step S14.

For example, when n=1 in FIG. 13, the association determination unit 4 compares the node coordinates P (N1), an orientation θN1 (inflow 1) of the first inflow link, and an orientation θN1 (outflow 1) of the first outflow link that are included in the first node information with the association information. Then, the association determination unit 4 extracts the second link a that is associated with the node coordinates P (N1) and the orientation θN1 (inflow 1) of the first inflow link, and the second link c that is associated with the node coordinates P (N1) and the orientation θN1 (outflow 1) of the first outflow link. Here, both of the second link a and the second link c are adopted as second links associated with the first node information. Then, a storage that is not illustrated stores the second links associated with the first node information in Step S13. The storage storing the second links may be a storage included in the route information creation apparatus 8 or a storage outside the route information creation apparatus 8, such as a register of a central processing unit (CPU) or a cache memory of a system on a chip (SoC).

When n=2 in FIG. 13, the association determination unit 4 compares the node coordinates P (N2), an orientation θN2 (inflow 1) of the first inflow link, and an orientation θN2 (outflow 1) of the first outflow link which are included in the first node information, with the association information. Then, the association determination unit 4 extracts the second link e associated with the node coordinates P (N2) and the orientation θN2 (inflow 1) of the first inflow link, and the second link g associated with the node coordinates P (N2) and the orientation θN2 (outflow 1) of the first outflow link. Then, the storage that is not illustrated stores the second links (the second links e and g) associated with the first node information in Step S13.

For example, when n=3 in FIG. 13, the association determination unit 4 compares the node coordinates P (N3), an orientation θN3 (inflow 1) of the first inflow link, and an orientation θN3 (outflow 1) of the first outflow link which are included in the first node information, with the association information. Then, the association determination unit 4 extracts the second link h associated with the node coordinates P (N3) and the orientation θN3 (inflow 1) of the first inflow link, and the second link i associated with the node coordinates P (N3) and the orientation θN3 (outflow 1) of the first outflow link. Then, the storage that is not illustrated stores the second links (the second links h and i) associated with the first node information in Step S13.

When the association determination unit 4 determines the absence of the second link associated with the first node information in Step S12, the storage that is not illustrated stores the absence of the second link associated with the first node information in Step S14.

In Step S15, the association determination unit 4 adds “1” to n.

In Step S16, the association determination unit 4 determines whether a process of comparing all pieces of the first node information (N pieces of the first node information) with the association information has been completed. When the process has been completed, the processes proceed to Step S17. When the process is not completed, the processes return to Step S12.

In Step S17, the second route information creating unit 5 creates the second route information based on the second link associated with the first node information. Specifically, the second route information creating unit 5 creates the second route information including the second route on the second map which is associated with the first route, using a plurality of the second links stored by the storage in Step S13.

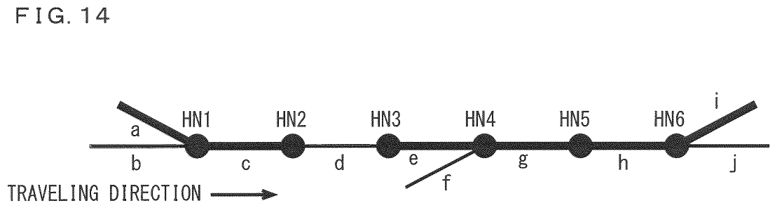

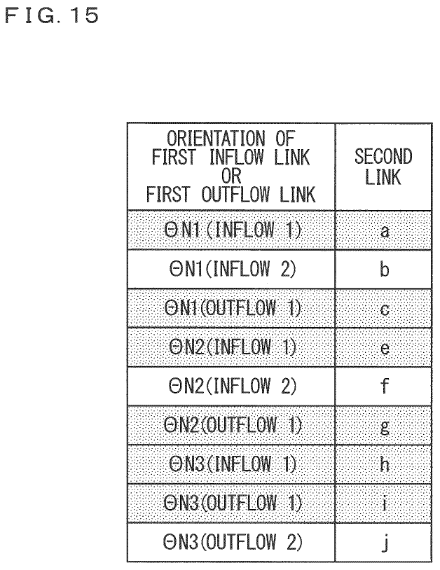

FIG. 14 illustrates an example of the second route information obtained through a primary process. The thick lines in FIG. 14 indicate link rows including the second links a, c, e, g, h, and i stored by the storage in Step S13. FIG. 15 illustrates the association information. Hatched portions in FIG. 15 each indicate that the second link for the first node information is extracted.

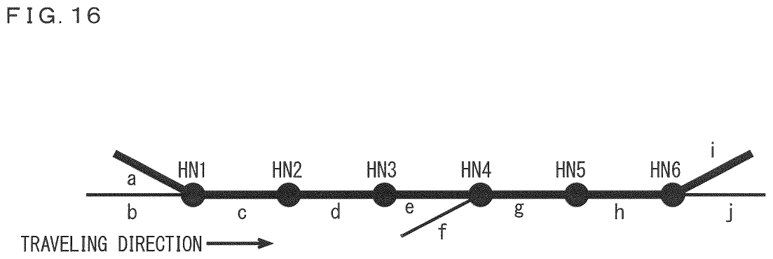

The second route information creating unit 5 performs a complement process such that the link rows including the second links become continuous. FIG. 16 illustrates an example of the second route information obtained through the complement process. As illustrated in FIG. 16, the second route information creating unit 5 complements the second link d to create the second route information including the second route that is one link row consisting of the second links a, c, d, e, g, h, and i.

In Step S18, the route information creation apparatus 8 determines whether the vehicle has stopped traveling. When the vehicle has stopped traveling, the operations in FIG. 3 end. When the vehicle does not stop traveling, the processes return to Step S10.

When the operations in FIG. 3 end, the second route information creating unit 5 outputs the created second route information to the driving assistance information formulation device 9. The driving assistance information formulation device 9 formulates driving assistance information on traveling through the second route, based on the second route information created by the second route information creating unit 5, the second map (the road shape information and the lane shape information on the second route) stored in the second map DB 14, and the position of the vehicle which has been determined by the positioning device 10. The driving assistance system 11 provides driving assistance to the driver of the vehicle, based on the driving assistance information obtained from the driving assistance information formulation device 9.

When the second route is accurately created by the complement process as illustrated in FIG. 16, the association information for the redundant second links in the association information may be represented by “null (0)”. For example, one of the second inflow link or the second outflow link associated with the first node information, for example, association information for the second links c, g, and h may be “null”.

Furthermore, when the second link associated with the specific first node information includes two links, namely, the second inflow link and the second outflow link, the association determination unit 4 may select one or both of the second inflow link and the second outflow link according to a predefined second link selection rule. The second link selection rule is, for example, a rule of selecting, in the presence of a plurality of first outflow links and one first inflow link for the one first node, not the first inflow link but each of the first outflow links as the second link, selecting, in the presence of a plurality of first inflow links and one first outflow link for the one first node, not the first outflow link but each of the first inflow links as the second link, and selecting, in the presence of one first inflow link and one first outflow link for the one first node, the one first inflow link and the one first outflow link as the second links.

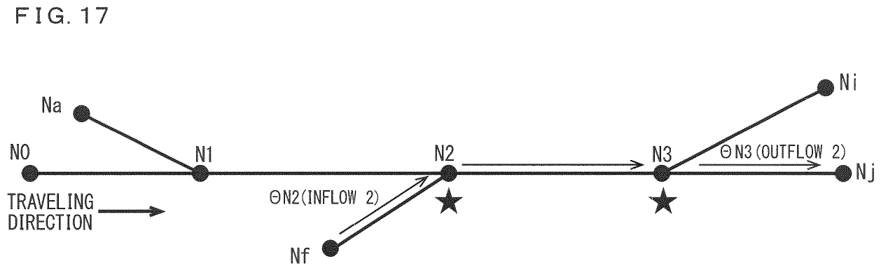

FIG. 17 illustrates an example of the first route information. FIG. 17 illustrates a case where the application executing unit 13 of the information processing device 7 has searched the first route that passes through the first nodes Nf→N2→N3→Nj. Here, the first route information obtaining unit 2 of the route information creation apparatus 8 obtains the first route information including the first node information in the first nodes N2 and N3 (star marks in FIG. 17) from the information processing device 7.

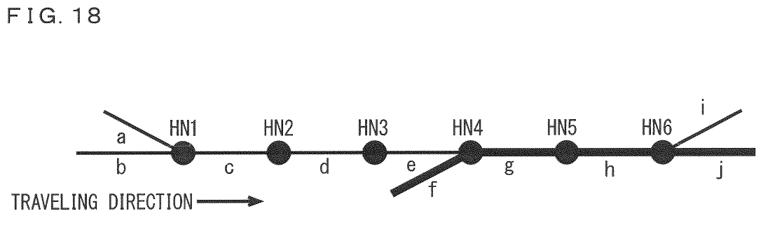

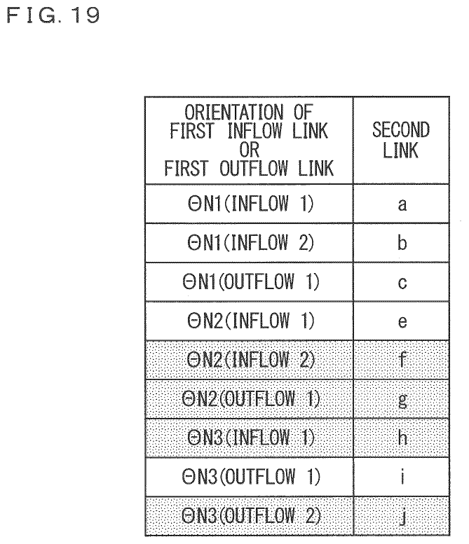

FIG. 18 illustrates an example of the second route information created by the second route information creating unit 5. The thick lines in FIG. 18 indicate the second route corresponding to the first route in FIG. 17. Furthermore, FIG. 19 illustrates the association information. Hatched portions in FIG. 19 each indicate that the second link for the first node information is extracted.

As illustrated in FIG. 18, the second route information creating unit 5 creates the second route in which link rows of the second links are continuous. Here, the second route information creating unit 5 need not perform the complement process.

What is described above is that the first map and the second map have the same road topology. Hereinafter, a case where the first map and the second map have different road topologies (examples 1 to 4) will be described.

### Example 1 Where First Map and Second Map Have Different Road Topologies

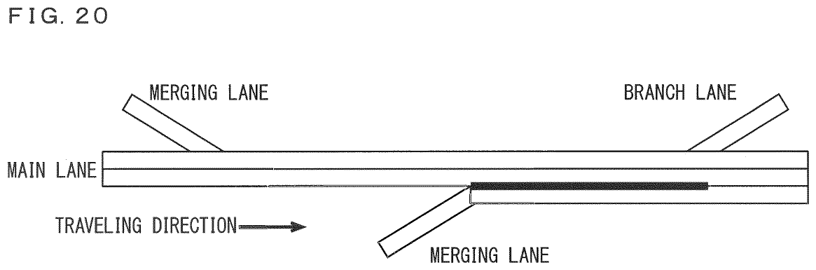

FIG. 20 illustrates an example real road geometry. FIG. 20 illustrates two merging lanes and one branch lane with respect to a main lane consisting of two lanes. Furthermore, when a vehicle enters the main lane from the merging lane in the middle of FIG. 20 (hereinafter may be referred to as a “middle merging lane”), a section from a position at which the vehicle enters the main lane from the merging lane to a position of the branch lane is a lane change prohibition section (a bold portion in FIG. 20), and, for example, a rule defines that the vehicle entering from the middle merging lane cannot escape through the branch lane.

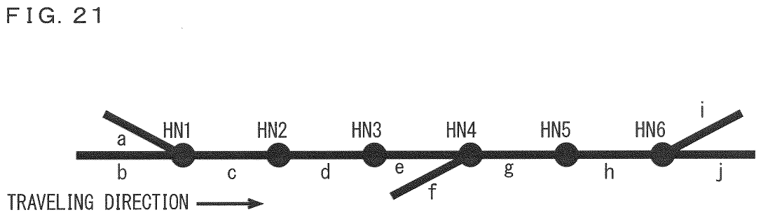

FIG. 21 illustrates an example road topology that represents the road geometry in FIG. 20 using the second map. As illustrated in FIG. 21, the road topology in the second map is identical to a road topology in the real road geometry in FIG. 20.

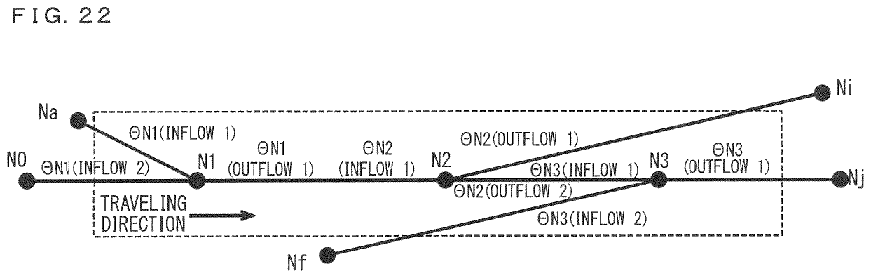

FIG. 22 illustrates an example road topology that represents the road geometry in FIG. 20 using the first map. The range of the first map enclosed by a dashed line in FIG. 22 corresponds to the range of the second map in FIG. 21.

As illustrated in FIG. 22, the road topology on the first map is different from the road topology in the real road geometry in FIG. 20. Specifically, the first link corresponding to the second link f connected to the second node HN4 (see FIG. 21) is connected to not the first node N2 but the first node N3. Furthermore, the first link corresponding to the second link i connected to the second node HN6 is connected to not the first node N3 but the first node N2. In other words, the first link N2-Ni and the first link Nf-N3 on the first map, and the second link i and the second link f on the second map, respectively, are interchanged in road topology between front and rear positions in the traveling direction. This occurs because the application executing unit 13 intentionally changes the road topology on the first map to prevent the vehicle entering from the second link f from searching for the first route that allows the vehicle to escape from the second link i.

Thus, the route information creation apparatus 8 according to the embodiment is characterized by using the association information so that the route information creation apparatus 8 can properly create the second route based on the first route information, even when the first map and the second map have different road topologies.

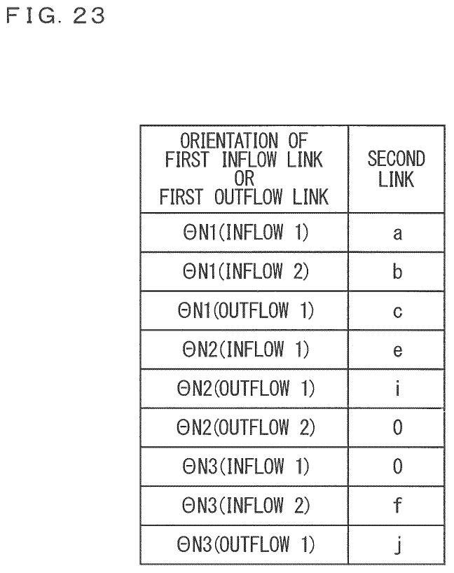

The association information in FIG. 23 includes association information when the first map and the second map have different road topologies. For example, the first inflow link θN2 (inflow 1) flowing into the first node N2 is associated with the second link e having the same road topology on the second map. Furthermore, since the first outflow link θN2 (outflow 2) is restored by the complement process of the second route information creating unit 5, the second link associated with the first outflow link θN2 (outflow 2) is “none=0 (null)”. Although the second link need not always be “null”, a unique route cannot be created in some cases when differences in road topology between the first map and the second map are complicatedly involved. In such cases, the association information creating system sometimes creates “null” information in advance. Similarly, although the first inflow link θN3 (inflow 2) flowing into the first node N3 has no second link identical in road topology on the second map, the second link f is associated as the second link for the first inflow link θN3 (inflow 2).

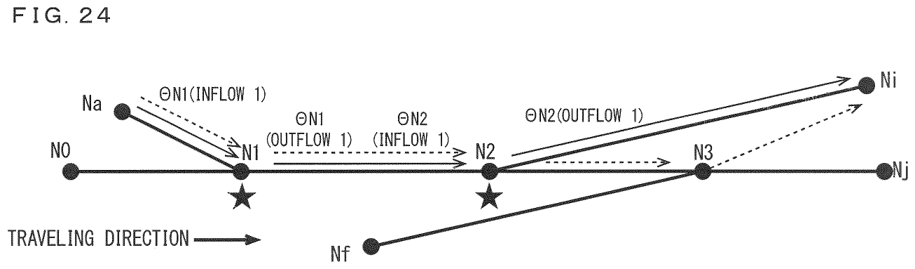

FIG. 24 illustrates an example of the first route information. In FIG. 24, solid arrows represent the first route on the first map, and dashed arrows represent the second route on the second map which corresponds to the first route.

In the example of FIG. 24, the first route information obtaining unit 2 obtains the first route information including the first node information on the first nodes N1 and N2. The association determination unit 4 extracts the second links a and c as the second links associated with the first node N1, and extracts the second links e and i as the second links associated with the first node N2. Since the first node information including the first node N3 is information other than the first route searched by the application executing unit 13, the information processing device 7 does not output the first node information.

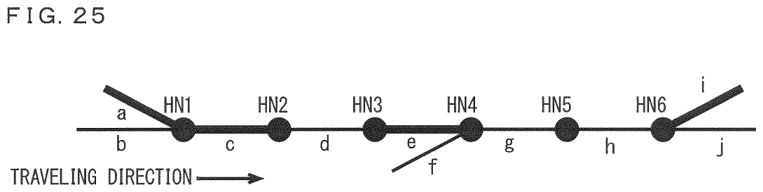

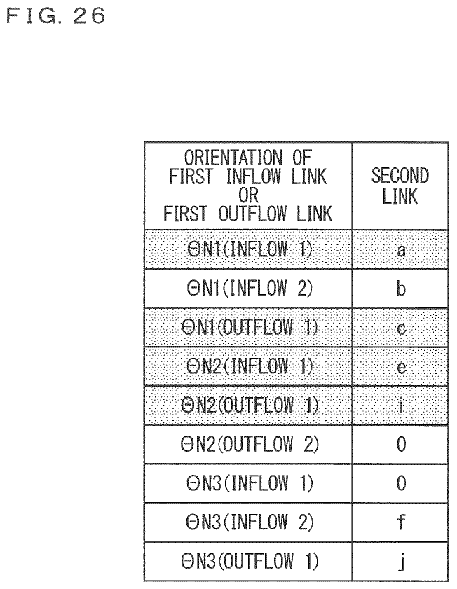

FIG. 25 illustrates an example of the second route information obtained through the primary process. The thick lines in FIG. 25 indicate link rows including the second links a, c, e, and i stored by the storage in Step S13 in FIG. 3. FIG. 26 illustrates the association information. Hatched portions in FIG. 26 each indicate that the second link for the first node information is extracted.

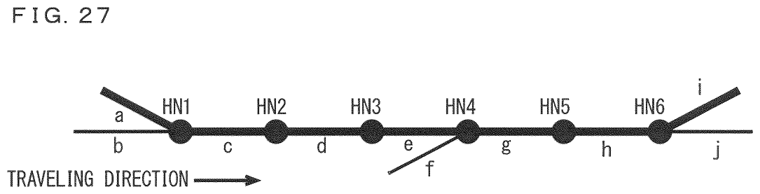

FIG. 27 illustrates an example of the second route information obtained through the complement process. As illustrated in FIG. 27, the second route information creating unit 5 complements the second links d, g, h to create the second route information including the second route that is one link row consisting of the second links a, c, d, e, g, h, and i.

### Example 2 Where First Map and Second Map Have Different Road Topologies

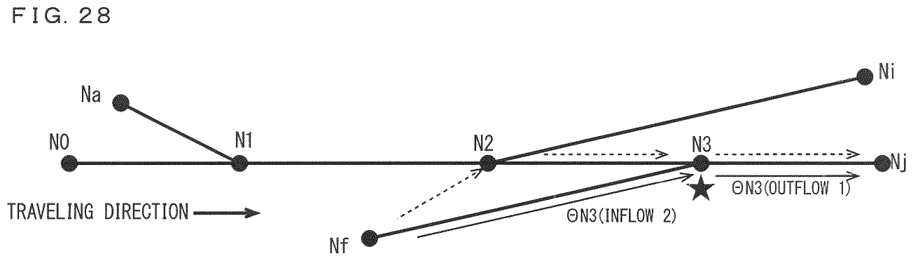

FIG. 28 illustrates an example of the first route information. In FIG. 28, solid arrows represent the first route on the first map, and dashed arrows represent the second route on the second map which corresponds to the first route.

In the example of FIG. 28, the first route information obtaining unit 2 obtains the first route information including the first node information on the first node N3. The association determination unit 4 extracts the second links f and j as the second links associated with the first node N3. Since the first node information including the first node N2 is information other than the first route searched by the application executing unit 13, the information processing device 7 does not output the first node information.

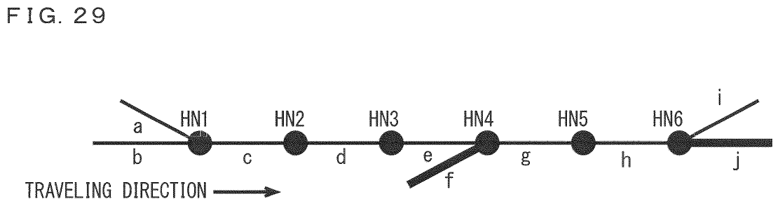

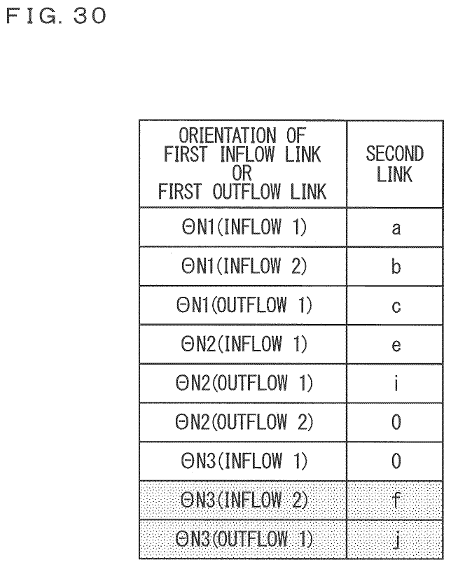

FIG. 29 illustrates an example of the second route information obtained through the primary process. The thick lines in FIG. 29 indicate link rows including the second links f and j stored by the storage in Step S13 in FIG. 3. FIG. 30 illustrates the association information. Hatched portions in FIG. 30 each indicate that the second link for the first node information is extracted.

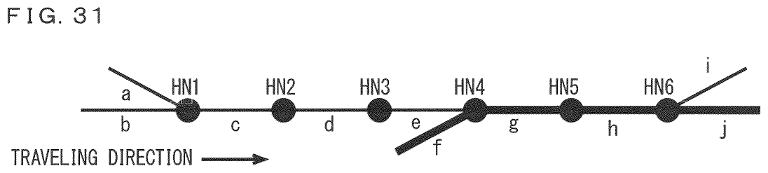

FIG. 31 illustrates an example of the second route information obtained through the complement process. As illustrated in FIG. 31, the second route information creating unit 5 complements the second links g and h to create the second route information including the second route that is one link row consisting of the second links f, g, h, and j.

### Example 3 Where First Map and Second Map Have Different Road Topologies

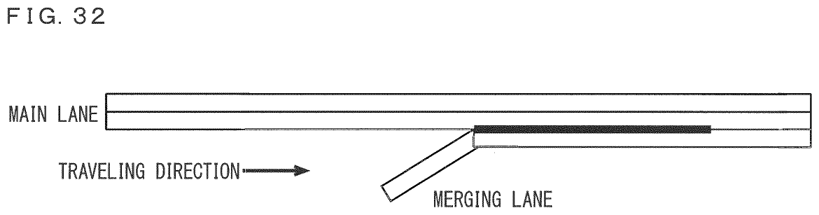

FIG. 32 illustrates an example real road geometry. FIG. 32 illustrates one merging lane with respect to a main lane consisting of two lanes. When a vehicle enters the main lane from the merging lane, a section from a position at which the vehicle enters the main lane from the merging lane to a predefined position is a lane change prohibition section (a bold portion in FIG. 32), so that the vehicle entering from the merging lane cannot change a lane within a certain distance after the merging.

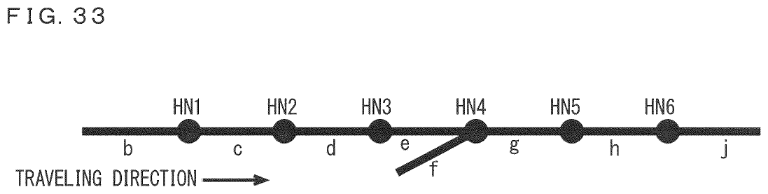

FIG. 33 illustrates an example road topology that represents the road geometry in FIG. 32 using the second map. As illustrated in FIG. 33, the second links e and f are connected to the second node HN4.

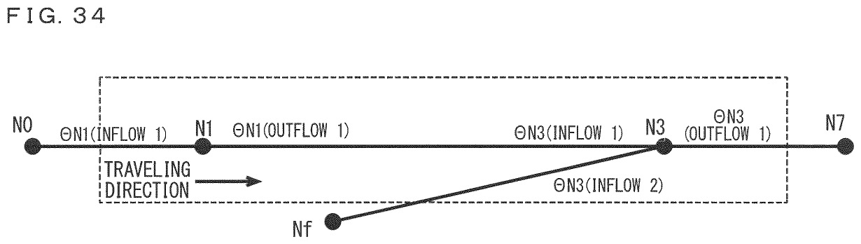

FIG. 34 illustrates an example road topology that represents the road geometry in FIG. 32 using the first map. The range of the first map enclosed by a dashed line in FIG. 34 corresponds to the range of the second map in FIG. 33.

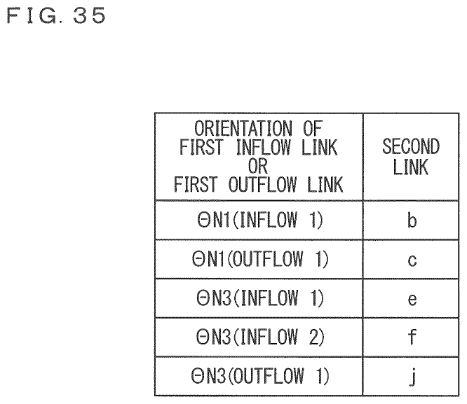

As illustrated in FIG. 34, the first link corresponding to the second link f is represented as the first inflow link Nf-N3 flowing into not the second node HN4 but the second node HN6. The first map and the second map have different road topologies. This is because a merging point to which the application executing unit 13 guides the vehicle along the first route is not a point corresponding to the second node HN4 but the first node N3, and the application executing unit 13 makes route guide announcement for the merging with proper timing. The association information in FIG. 35 includes association information when the first map and the second map have different road topologies.

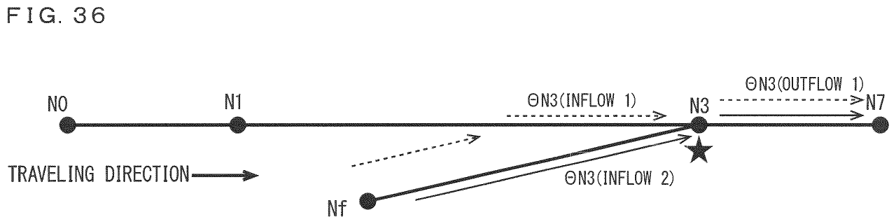

FIG. 36 illustrates an example of the first route information. In FIG. 36, solid arrows represent the first route on the first map, and dashed arrows represent the second route on the second map which corresponds to the first route.

In the example of FIG. 36, the first route information obtaining unit 2 obtains the first route information including the first node information on the first node N3. The association determination unit 4 extracts the second links f and j as the second links associated with the first node N3.

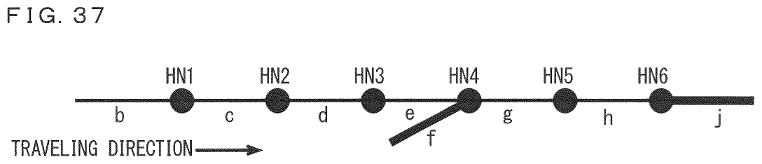

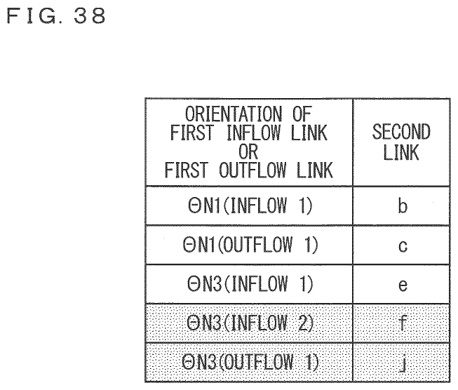

FIG. 37 illustrates an example of the second route information obtained through the primary process. The thick lines in FIG. 37 indicate link rows including the second links f and j stored by the storage in Step S13 in FIG. 3. FIG. 38 illustrates the association information. Hatched portions in FIG. 38 each indicate that the second link for the first node information is extracted.

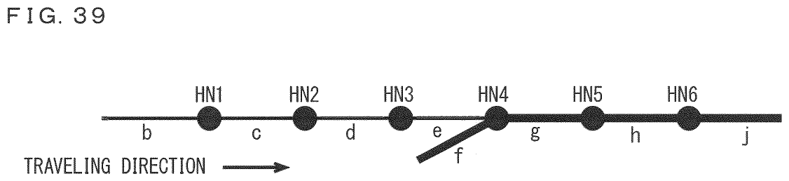

FIG. 39 illustrates an example of the second route information obtained through the complement process. As illustrated in FIG. 39, the second route information creating unit 5 complements the second links g and h to create the second route information including the second route that is one link row consisting of the second links f, g, h, and j.

### Example 4 Where First Map and Second Map Have Different Road Topologies

This example 4 will describe a case where the second map does not include the second link corresponding to the first link existing in the first map. Examples where such circumstances occur include a case where policies of adopting road links in the first map and the second map are different and the second link corresponding to the first link is not created in the second map on purpose, and a case where differences in development period between the first map DB 12 and the second map DB 14 allow the first link corresponding to the second link that has not existed in developing the second map DB 14 to exist in developing the first map DB 12.

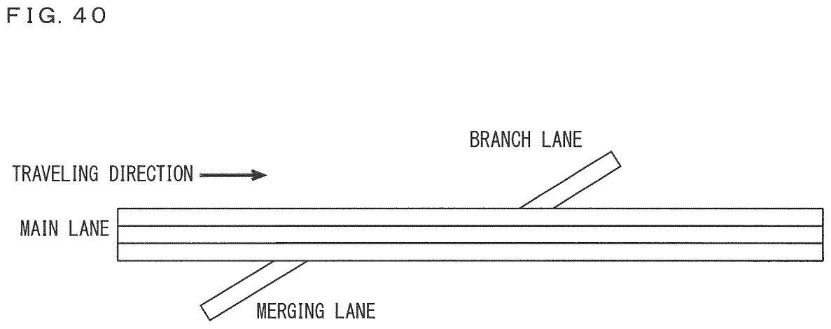

FIG. 40 illustrates an example real road geometry. FIG. 40 illustrates one merging lane and one branch lane with respect to a main lane consisting of two lanes.

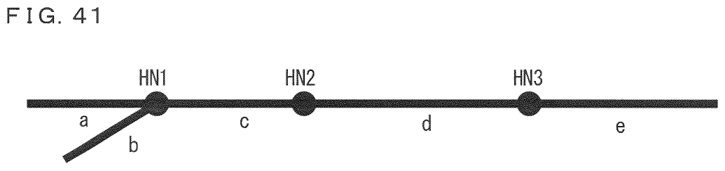

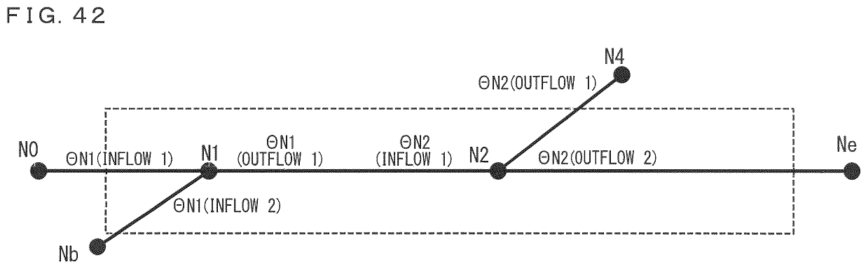

FIG. 41 illustrates an example road topology that represents the road geometry in FIG. 40 using the second map. As illustrated in FIG. 41, the second map does not include the branch lane corresponding to the first link N2-N4 (see FIG. 42) on the first map, due to a map creating policy.

FIG. 42 illustrates an example road topology that represents the road geometry in FIG. 40 using the first map. The range of the first map enclosed by a dashed line in FIG. 42 corresponds to the range of the second map in FIG. 41.

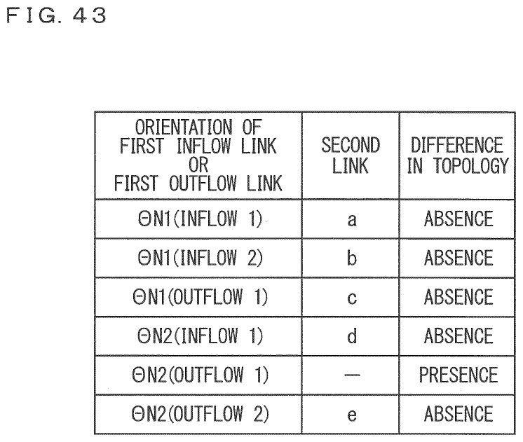

As illustrated in FIG. 42, the first map includes the first link N2-N4 (the orientation θN2 (outflow 1) of the first outflow link) flowing out of the first node N2. Here, there is no second link (null) associated with the orientation θN2 (outflow 1) of the first outflow link in the association information in FIG. 43. Alternatively, the orientation θN2 (outflow 1) may be associated with the second link that is the closest to N2 coordinates on the second map. Furthermore, the association information may supplementarily include a presence/absence flag on “difference in topology” indicating the presence or absence of differences in road topology between the first map and the second map as illustrated in FIG. 43.

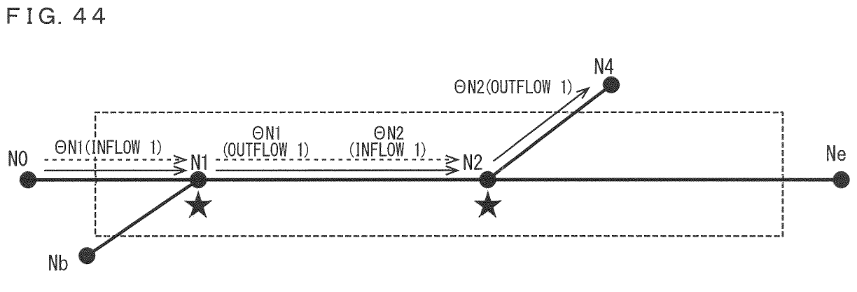

FIG. 44 illustrates an example of the first route information. In FIG. 44, solid arrows represent the first route on the first map, and dashed arrows represent the second route on the second map which corresponds to the first route.

In the example of FIG. 44, the first route information obtaining unit 2 obtains the first route information including the first node information on the first nodes N1 and N2. The association determination unit 4 extracts the second links a, c, and d as the second links associated with the first nodes N1 and N2.

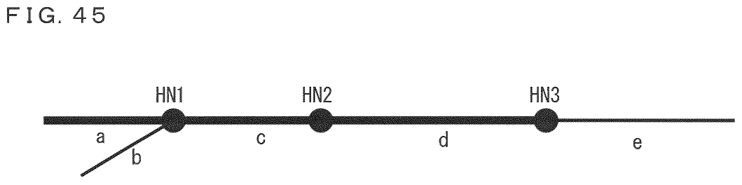

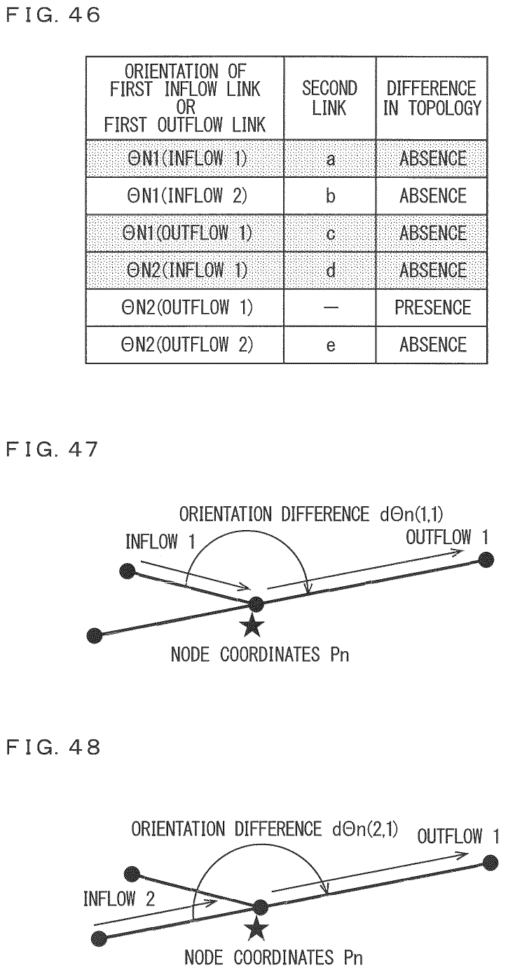

FIG. 45 illustrates an example of the second route information. The thick lines in FIG. 45 indicate link rows including the second links a, c, and d stored by the storage in Step S13 in FIG. 3. FIG. 46 illustrates the association information. Hatched portions in FIG. 46 each indicate that the second link for the first node information is extracted. As illustrated in FIGS. 45 and 46, the second link corresponding to the first link N2-N4 flowing out of the first node N2 does not exist. Thus, the second route information creating unit 5 ends the creating process on the second route at the second link d as the end. Then, when the first route information obtaining unit 2 obtains the first route information again, the second route information creating unit 5 resumes the creating process on the second route. When the vehicle enters the second link existing in the second map from the first link existing only in the first map, the second route information creating unit 5 starts or resumes the creating process on the second route.

### Modification 1

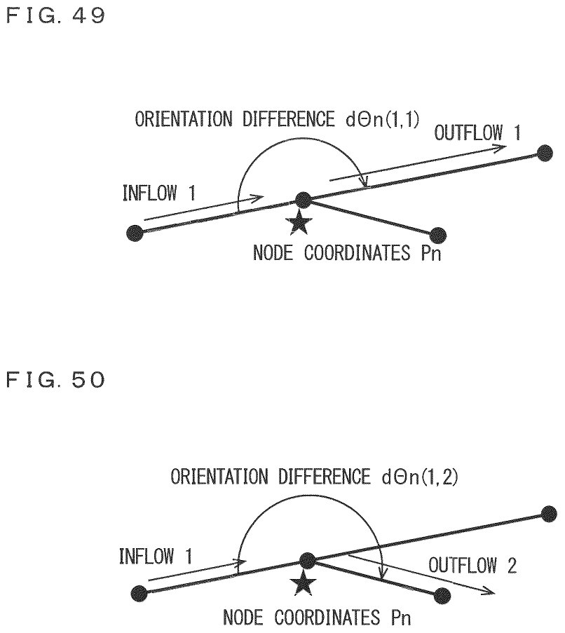

Although the first node information described in the embodiment includes the node coordinates Pn, the inflow orientation θn (inflow i), and the outflow orientation θn (outflow j) on the first node n, the first node information may include information other than these pieces of information as long as the first node information is information for identifying the first node. For example, the first node information may include, on the first node n, the node coordinates Pn, and an orientation difference dθn (i, j) between the inflow orientation θn (inflow i) and a relative outflow orientation θn (outflow j) when seen from the inflow orientation θn (inflow i). FIGS. 47 to 50 are diagrams for illustrating the first node information according to Modification 1.

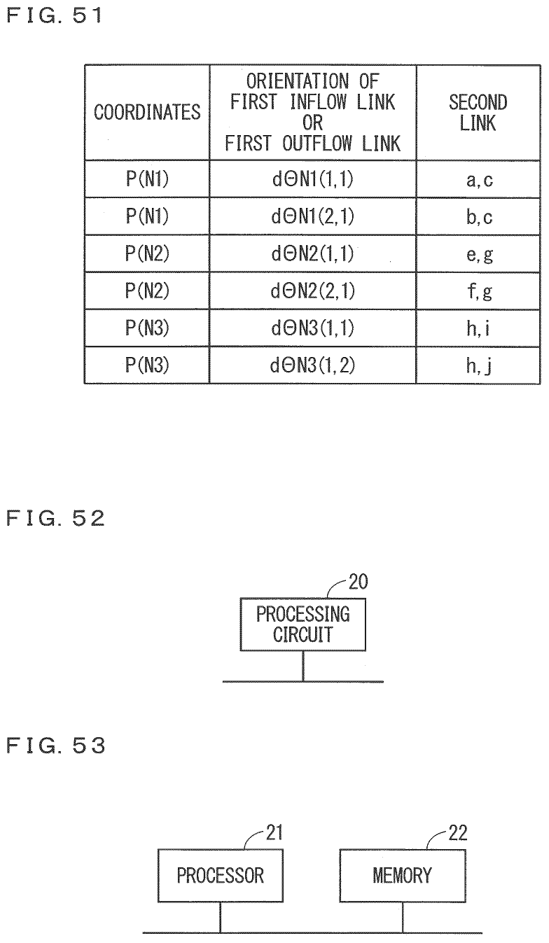

FIG. 51 illustrates example association information according to Modification 1. As illustrated in FIG. 51, two second links are associated with the single first node information. As described in the embodiment, one of these two second links may be adopted.

### Modification 2

The first route information output by the information processing device 7 may include type information indicating a type of the first map. Here, the route information creation apparatus 8 downloads association information corresponding to the type of the first map from an external server, based on the type information obtained from the information processing device 7, and stores the association information in the association information storage 15. The association information storage 15 may rewrite the existing association information into new association information.

With such a configuration, the route information creation apparatus 8 can properly create the second route information even when using another information processing device (an IVI system) with a different road creation policy.

### Modification 3

Although the embodiment describes the second map as a high-definition map with a road shape information on a per lane basis, the second map is not limited to a high-definition map but should be a map different in format from the first map.

### Hardware Configuration

A processing circuit implements functions of the first route information obtaining unit 2, the association determination unit 4, and the second route information creating unit 5 in the route information creation apparatus 8 which are described in the embodiment. In other words, the route information creation apparatus 8 includes the processing circuit for obtaining the first route information, determining whether the first node information is associated with the second link, and creating the second route information. The processing circuit may be dedicated hardware, or a processor (also referred to as a central processing unit (CPU)), a processing unit, an arithmetic unit, a microprocessor, a microcomputer, or a digital signal processor (DSP)) which executes a program stored in a memory.

When the processing circuit is dedicated hardware, a processing circuit 20 as illustrated in FIG. 52 is, for example, a single circuit, a composite circuit, a programmed processor, a parallel-programmed processor, an application-specific integrated circuit (ASIC), a field-programmable gate array (FPGA), or any combination of these. Each of the functions of the first route information obtaining unit 2, the association determination unit 4, and the second route information creating unit 5 may be performed by the processing circuit 20, or the functions may be collectively performed by the single processing circuit 20.

When the processing circuit 20 is a processor 21 in FIG. 53, the functions of the first route information obtaining unit 2, the association determination unit 4, and the second route information creating unit 5 are implemented by, for example, software, firmware, or a combination of the software and the firmware. The software or the firmware is described as a program, and stored in a memory 22. The processor 21 performs the functions by reading and executing programs stored in the memory 22. In other words, the route information creation apparatus 8 includes the memory 22 for storing the programs which consequently execute a step of obtaining the first route information, a step of determining whether the first node information is associated with the second link, and a step of creating the second route information. Moreover, these programs cause a computer to execute procedures or methods of the first route information obtaining unit 2, the association determination unit 4, and the second route information creating unit 5. Here, examples of the memory may include non-volatile or volatile semiconductor memories such as a random access memory (RAM), a read-only memory (ROM), a flash memory, an erasable programmable read-only memory (EPROM), an electrically erasable programmable read-only memory (EEPROM), a magnetic disc, a flexible disk, an optical disk, a compact disk, a digital versatile disc (DVD), and further any storage medium to be used in the future.

A part of the functions of the first route information obtaining unit 2, the association determination unit 4, and the second route information creating unit 5 may be performed by dedicated hardware, and the other functions may be performed by software or firmware.

As described above, the processing circuit can implement each of the functions by hardware, software, firmware, or any combinations of these.

The embodiment can be appropriately modified and omitted within the scope of the present disclosure.

While the present disclosure is described in detail above, the foregoing description is in all aspects illustrative and does not restrict the disclosure. It is understood that numerous modifications that have not yet been exemplified can be devised.

### EXPLANATION OF REFERENCE SIGNS

1 route information creation apparatus, 2 first route information obtaining unit, 3 second map obtaining unit, 4 association determination unit, 5 second route information creating unit, 6 in-vehicle apparatus, 7 information processing device, 8 route information creation apparatus, 9 driving assistance information formulation device, 10 positioning device, 11 driving assistance system, 12 first map DB, 13 application executing unit, 14 second map DB, 15 association information storage, 20 processing circuit, 21 processor, 22 memory.

1. A route information creation apparatus, comprising:
a processor to execute a program; and
a memory to store the program which, when executed by the processor, performs processes of:
obtaining first route information including at least first node information including information for determining an inflow link or an outflow link, in a first route calculated using a first map including road shape information on a per road basis;
obtaining a second map including road shape information represented by a format different from a format of the first map;
determining whether the first node information included in the obtained first route information is associated with at least one second link, based on the first route information and association information indicating a correspondence between the first node information in the first map and the second link in the second map; and
creating second route information in a second route on the second map which corresponds to the first route, based on the second link determined with which the first node information is associated and based on the obtained second map, the second route information including the second link,
wherein when a second node on the second map which corresponds to a specific first node on the first map does not include a second outflow link that flows out of the second node on the second map which corresponds to a first outflow link that flows out of the specific first node, the association information includes information for associating, with the first outflow link, an other second outflow link that flows out of an other second node in a vicinity of the second node, and when the second node does not include a second inflow link that flows into the second node on the second map which corresponds to a first inflow link that flows into the specific first node, the association information includes information for associating, with the first inflow link, an other second inflow link that flows into an other second node in the vicinity of the second node.

2. The route information creation apparatus according to claim 1,
wherein when a second node on the second map which corresponds to a specific first node on the first map includes the second outflow link on the second map which corresponds to the first outflow link that flows out of the specific first node, the association information includes information for associating the first outflow link with the second outflow link, and when the second node includes the second inflow link on the second map which corresponds to the first inflow link that flows into the specific first node, the association information includes information for associating the first inflow link with the second inflow link.

3. The route information creation apparatus according to claim 1,
wherein the first node information includes first node coordinates that are coordinates of a first node, a first inflow link orientation that is an orientation of the first inflow link that flows into the first node in the first route, and a first outflow link orientation that is an orientation of the first outflow link that flows out of the first node in the first route, and
the association information includes information for associating a pair of the first node and the first inflow link orientation with the second link, and information for associating a pair of the first node and the first outflow link orientation with the second link.

4. The route information creation apparatus according to claim 1,
wherein the second map includes road shape information on a per lane basis.

5. The route information creation apparatus according to claim 1,
wherein when in a second node group which consists of a plurality of second nodes that are continuous on the second map and which have a geometric correspondence with a first node group consisting of a plurality of first nodes that are continuous on the first map, a first link that branches or merges from the first node group and the second link that branches or merges from the second node group which corresponds to the first link are interchanged in topology between front and rear positions in a traveling direction, the association information includes information for associating the second link with the first inflow link or the first outflow link having a correspondence with the second link.

6. The route information creation apparatus according to claim 4,
wherein in a road structure that does not allow a vehicle to escape from a next specific branch lane to an outside of a main lane due to an influence of a lane change prohibition section defined in the main lane after the vehicle enters the main lane from a specific merging lane, the association information indicates the correspondence, based on the first map in which a first link indicating the merging lane and a first link indicating the branch lane have been interchanged between front and rear positions in a traveling direction and based on the second map in which a second link indicating the merging lane and a second link indicating the branch lane are not interchanged between front and rear positions in the traveling direction.

7. The route information creation apparatus according to claim 4,
wherein in a road structure that does not allow a vehicle to escape from a next specific branch lane to an outside of a main lane due to an influence of a lane change prohibition section defined in the main lane after the vehicle enters the main lane from a specific merging lane, the association information indicates the correspondence, based on the first map and the second map which differ in coordinates of the first node to which a first link indicating the merging lane is connected and which differ in coordinates of the second node to which the second link corresponding to the first link is connected, respectively.

8. The route information creation apparatus according to claim 1,
wherein when the second map does not include the second link which corresponds to the first outflow link that flows out of a first node included in the first node information or the first inflow link that flows into the first node, the association information includes information indicating an absence of the second link or information indicating that the first map and the second map have different topologies.

9. The route information creation apparatus according to claim 8,
wherein when the second map does not include the second link corresponding to a first link on the first map, the processes comprise creating the second route information in the second route up to the second link corresponding to the first link on the first map.

10. The route information creation apparatus according to claim 1,
wherein when a plurality of second links comprised in the at least one second link determined with which the first node information is associated are discontinuous, the processes comprise complementing a discontinuous portion between the second links using the second map to create the second route information in the second route.

11. The route information creation apparatus according to claim 1,
wherein the first route information includes type information indicating a type of the first map, and
the association information is information corresponding to the type information,

12. The route information creation apparatus according to claim 1,
wherein when it is determined that the first node information is associated with the second link including the second inflow link and the second outflow link, the processes comprise selecting at least one of the second inflow link or the second outflow link, according to a predefined second link selection rule.

13. The route information creation apparatus according to claim 12,
wherein when the first node has a plurality of first outflow links and the first inflow link, the processes comprise determining that each of the first outflow links is associated with the second link, when the first node has a plurality of first inflow links and the first outflow link, the processes comprise determining that each of the first inflow links is associated with the second link, and when the first node has the first inflow link and the first outflow link, the processes comprise determining that the first inflow link and the first outflow link are associated with the second link.

14. A method of creating route information, comprising:
obtaining first route information including at least first node information including information for determining an inflow link or an outflow link, in a first route calculated using a first map including road shape information on a per road basis;
obtaining a second map including road shape information represented by a format different from a format of the first map;
determining whether the first node information included in the first route information is associated with at least one second link, based on the first route information and association information indicating a correspondence between the first node information in the first map and the second link in the second map; and
creating second route information in a second route on the second map which corresponds to the first route, based on the second link determined with which the first node information is associated and based on the second map, the second route information including the second link,
wherein in an absence of a second outflow link that flows out of a second node on the second map which corresponds to a first outflow link that flows out of a first node on the first map, the association information includes information for associating, with the first outflow link, an other second outflow link that flows out of an other second node in a vicinity of the second node, and in an absence of a second inflow link that flows into the second node on the second map which corresponds to a first inflow link that flows into the first node on the first map, the association information includes information for associating, with the first inflow link, an other second inflow link that flows into an other second node in the vicinity of the second node.
